(19) United States
(12) Patent Application Publication
(10) Pub. No.: US 2025/0284502 A1
(43) Pub. Date: Sep. 11, 2025

(54) PLUG AND PLAY EXPLAINABLE ARTIFICIAL INTELLIGENCE SYSTEM AND DESIGN METHOD THEREOF

(71) Applicant: Konan Technology Inc., Seoul (KR)

(72) Inventors: Juhyun LEE, Gunpo-si (KR); Kyeongsoo KIM, Seoul (KR); Jaehyeok JEONG, Seoul (KR); Hyeongdo LEE, Seongnam-si (KR); Hyunsu KANG, Yongin-si (KR)

(73) Assignee: Konan Technology Inc., Seoul (KR)

(21) Appl. No.: 18/629,092

(22) Filed: Apr. 8, 2024

(30) Foreign Application Priority Data
Mar. 8, 2024 (KR) 10-2024-0033233

(51) Int. Cl. G06F 9/4401

(52) U.S. Cl. CPC G06F 9/4413

(57) ABSTRACT

Provided are a plug-and-play explainable artificial intelligence (PnP XAI) system and a design method thereof. The PnP XAI system and the design method thereof, upon receiving a model configuration file from a user, configure a machine learning model using the received model configuration file, calculate an XAI algorithm of the configured machine learning model, and provide the calculated result.

### CROSS-REFERENCE TO RELATED APPLICATION(S)

This application claims the benefit under 35 USC § 119(a) of Korean Patent Application No. 10-2024-0033233, filed on Mar. 8, 2024, in the Korean Intellectual Property Office, the entire disclosure of which is incorporated herein by reference for all purposes.

### BACKGROUND

### 1. Field

The following description relates to a technology for describing a determination basis for inference results of a machine learning model in a manner understandable to humans.

### 2. Description of Related Art

As the development of machine learning technology continues to have a significant impact on various fields, most machine learning techniques reveal limitations in explaining their internal decision-making basis. Consequently, there is a growing need for explainable artificial intelligence (XAI) technology that can explain the rationale behind the decisions made by machine learning models.

XAI is used to explain AI models and their expected impacts and potential biases. It is useful in characterizing model accuracy, fairness, transparency, and outcomes in AI-driven decision-making. XAI plays a crucial role in building trust and confidence when organizations deploy AI models for production. In addition, explainability through AI helps organizations adopt a responsible approach to AI development.

XAI systems currently available on the market require the separate application of individual XAI techniques, have limited types of XAI algorithms provided in each system, and entail the inconvenience of implementing functions for installing and providing libraries separately as additional code.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one embodiment, a plug-and-play explainable artificial intelligence (PnP XAI) system and a design method thereof are provided, which employ the plug-and-play concept of a computer system to reduce user inconvenience and maximize the performance of applying XAI algorithms.

In one general aspect, there is provided a PnP XAI system including a model import module configured to, upon installation of a program in a machine learning model used for training by a user, receive a model configuration file through user input via the installed program, configure a machine learning model using the received model configuration file, and return it to the user, a dataset import module configured to receive a dataset configuration file through user input via the installed program, configure a dataset using the received dataset configuration file, and return it to the user, a user manager module configured to receive the returned model and dataset through user input and adjust the received model and dataset into forms applicable to an explainable artificial intelligence (XAI) algorithm, a kernel manager module configured to receive the model and dataset adjusted into forms applicable to an XAI algorithm, and an XAI library module configured to receive a model and dataset information from the kernel manager module, calculate an XAI algorithm of a model, and return an XAI algorithm calculation result value to the kernel manager module.

The model configuration file may include location information of a file, model and dataset call information, XAI algorithm selection information, and parameter information necessary for calling a model.

The XAI library module may include an XAI algorithm sub-module, and the XAI algorithm sub-module may include at least one of layer-wise relevance propagation (LRP) sub-module, a gradient-class activation map (GradCAM) sub-module, or an integrated gradient (IG) sub-module.

The PnP XAI system may further include a model tracer module configured to receive a model from the XAI algorithm sub-module, analyze the received model to identify a computational structure of the model, and return algorithm calculation classes corresponding to the identified computational structure to the XAI algorithm sub-module, enabling the XAI algorithm sub-module to calculate the XAI algorithm.

The PnP XAI system may further include a visualization module configured to receive the XAI algorithm calculation result value from the kernel manager module and visualize it.

In another general aspect, there is provided a PnP XAI design method including installing a program in a machine learning model used for training by a user, receiving a model configuration file from the user through the installed program, configuring a machine learning model using the received model configuration file, calculating an XAI algorithm of the configured machine learning model, and visualizing a result including a value calculated with the XAI algorithm.

The PnP XAI design method may further include receiving a dataset configuration file from the user and configuring a dataset using the received dataset configuration file.

The PnP XAI design method may further include adjusting the configured model and dataset into forms applicable to an XAI algorithm.

In the calculating of the XAI algorithm the model may analyzed to identify a computational structure of the model and the XAI algorithm may be calculated using algorithm calculation classes corresponding to the identified computational structure.

Other features and aspects will be apparent from the following detailed description, the drawings, and the claims.

### BRIEF DESCRIPTION OF THE DRAWINGS

FIG. 1 is a diagram illustrating the configuration of a plug-and-play explainable artificial intelligence (PnP XAI) system according to an embodiment of the present invention.

FIG. 2 is a flowchart illustrating a PnP XAI design method according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The advantages and features of the present invention and the manner of achieving the advantages and features will become apparent with reference to embodiments described in detail below together with the accompanying drawings. However, the present invention may be implemented in many different forms and should not be construed as being limited to the embodiments set forth herein, and the embodiments are provided such that this disclosure will be thorough and complete and will fully convey the scope of the present invention to those skilled in the art, and the present invention is defined only by the scope of the appended claims. The same reference numerals refer to the same components throughout this disclosure.

In the following description of the embodiments of the present invention, if a detailed description of related known functions or configurations is determined to unnecessarily obscure the gist of the present invention, the detailed description thereof will be omitted herein. The terms described below are defined in consideration of the functions in the embodiments of the present invention, and these terms may be varied according to the intent or custom of a user or an operator. Therefore, the definitions of the terms used herein should follow contexts disclosed herein.

Hereinafter, embodiments of the present invention will be described in detail with reference to the accompanying drawings. However, the present invention may be realized in various forms, and the scope of the present invention is not limited to such embodiments. The embodiments of the present invention are provided to aid those skilled in the art in the explanation and the understanding of the present invention.

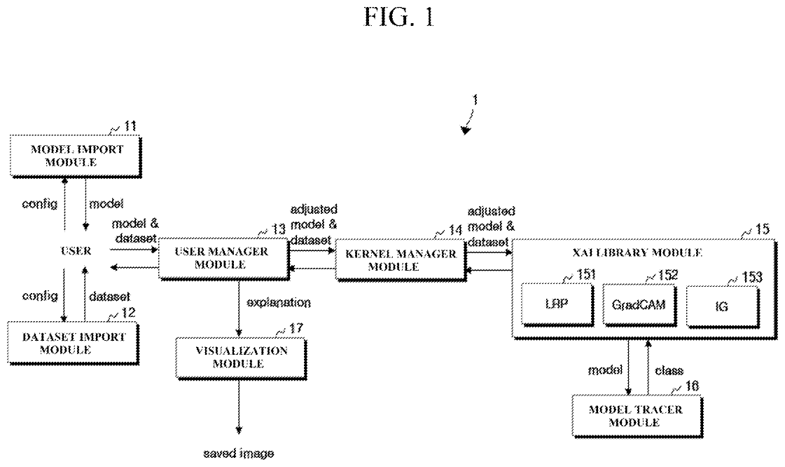

FIG. 1 is a diagram illustrating the configuration of a plug-and-play explainable artificial intelligence (PnP XAI, hereinafter simply referred to as “PnP XAI”) system according to an embodiment of the present invention.

Referring to FIG. 1, a PnP XAI system 1 may be implemented in the form of a computer program. The computer program may include one or more instructions implementing methods/operations according to various embodiments of the present invention.

PnP XAI refers to a system in which, similar to how a computer automatically recognize and install a driver when a USB is connected, the PnP XAI system 1 to recognize a machine learning model developed by a user, and, upon the user providing a few settings, promptly applies and compares/analyzes XAI algorithms of the corresponding machine learning model and provides the results. Thus, the structure of the PnP XAI system 1 has been designed with consideration of the versatility of machine learning models that can be recognized and the scalability to accommodate many XAI algorithms. Machine learning may include deep learning.

When the PnP XAI system 1 receives a configuration file of the machine learning model trained by the user, it automatically configures a machine learning model in an executable form using the configuration file. Then, the PnP XAI system 1 calculates an XAI algorithm of the configured machine learning model, and immediately provides the results, including the values calculated with the XAI algorithm, saved as an image to the user.

The PnP XAI system 1 may call the result values obtained by applying multiple XAI algorithms to the user's trained machine learning model. To this end, the PnP XAI system 1 automatically recognizes the user's trained machine learning model and, upon the user selecting a predetermined XAI algorithm provided in the software, directly provides the calculated result of the selected XAI algorithm without the need for a separate function call.

Referring to FIG. 1, the PnP XAI system 1 may include a model import module 11, a dataset import module 12, a user manager module 13, a kernel manager module 14, an XAI library module 15, and a visualization module 17, and may further include a model tracer module 16.

When a program is installed in the machine learning model used for training, the model import module 11 receives a configuration file of the machine learning model trained by the user through user input via the installed program, configures a model in an executable form using the received model configuration file, and returns it to the user. The model configuration file includes location information of a weight file, model and dataset call information, XAI algorithm selection information, and parameter information necessary for calling a model.

The model import module 11 may load classes that configure the remaining machine learning model using the code at the end of a model call function of the machine learning model trained by the user, and then configure the model to return it to the user.

The dataset import module 12 receives a dataset configuration file through user input via the installed program, configures a dataset in an executable form using the received dataset configuration file, and returns it to the user. The dataset configuration file includes information regarding the dataset that the user wishes to explain by applying the XAI algorithm.

The user manager module 13 receives the model and the dataset according to user input and adjusts the received model and dataset into forms applicable to the XAI algorithm before sending them to the kernel manager module 14.

When the user manager module 13 receives from the user the returned machine learning model and dataset and the configuration file related to the desired XAI algorithm, the user manager module 13 adjusts the model, the dataset, and the configuration information into forms that can be implemented and applied to the XAI algorithm before sending the adjusted model, dataset, and configuration information to the kernel manager module 14 that corresponds to the desired XAI algorithm.

The kernel manager module 14 transmits the adjusted model and dataset to the XAI library module 15 to which them are to be applied.

When the kernel manager module 14 sends the machine learning model and dataset information to a corresponding XAI algorithm sub-module within the XAI library module 15 that is capable of directly computing the desired XAI algorithm, the XAI library module 15 performs an XAI algorithm calculation through a predetermined XAI algorithm sub-module and returns the XAI algorithm calculation result value to the kernel manager module 14.

The XAI library module 15 includes at least one XAI algorithm sub-module. The XAI algorithm sub-module contains a calculation method using an XAI algorithm to explain an image in a machine learning model. Examples of the XAI algorithm sub-module include a layer-wise relevance propagation (LRP) sub-module 151, a gradient-class activation map (GradCAM) sub-module 152, and an integrated gradient (IG) sub-module 153.

LRP is a backpropagation-based method (BBM) that indicates the importance of each pixel by calculating the relevance of parameters or the last trained gradient of a trained deep learning model to the prediction of an input value through backpropagation.

Grad-CAM is an activation-based method (ABM) in which, in the case of a convolutional neural network (CNN)-based deep learning model, the average value of gradients of features in a convolutional layer to be explained is used as a weight.

Within the XAI library module 15, the LRP sub-module 151 sends the model to the model tracer module 16, and the model tracer module 16 detects the layer structure of the entire model and returns the classes through layer-wise calculation to the XAI library module 15.

The model tracer module 151 receives the model from the XAI algorithm sub-module, analyzes the received model to identify the computational structure of the model, and returns algorithm calculation classes corresponding to the identified computational structure to the XAI algorithm sub-module, enabling the XAI algorithm sub-module to calculate the XAI algorithm.

For example, in the case of XAI algorithm computation using backpropagation such as LRP, the LRP sub-module 151 within the XAI library module 15 sends the received model to the model tracer module 16. The model tracer module 16 analyzes bytecode of the received model to understand the computational structure of the machine learning model and returns algorithm computation classes corresponding to the identified computational structure to the LRP sub-module 151 within the library module 15, enabling the LRP sub-module 151 to compute LRP.

The XAI library module 15 sends the result value (explanation) calculated with the XAI algorithm to the kernel manager module 14, and the kernel manager module 14 transmits the result value (explanation) calculated with the XAI algorithm to the user manager module 13.

The user manager module 13 sends the calculated result value (explanation) to the visualization module 17, which visualizes it. The visualization module 17 may save an image visualized according to each XAI algorithm at a location desired by the user and provide it.

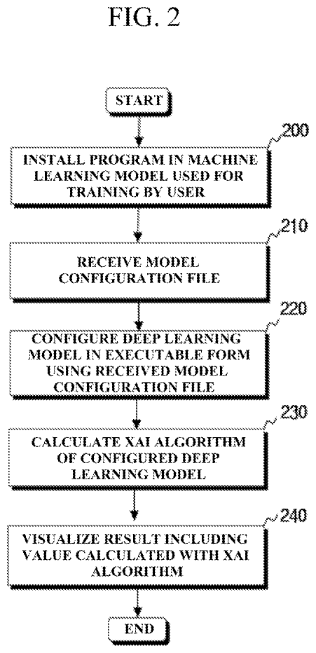

FIG. 2 is a flowchart illustrating a PnP XAI design method according to an embodiment of the present invention.

Referring to FIGS. 1 and 2, in 200, the PnP XAI system 1 has a program installed in the machine learning model used for training by a user.

Subsequently, in 210, the PnP XAI system 1 receives a model configuration file from the user through the installed program 210. In this case, the PnP XAI system 1 may configure a machine learning model using the received model configuration file and return it to the user.

Furthermore, the PnP XAI system 1 may receive the dataset configuration file through user input via the installed program, configures a dataset using the received dataset configuration file, and returns it to the user.

Next, in 220, the PnP XAI system 1 configures a machine learning model using the received model configuration file.

The PnP XAI system 1 may adjust the configured model and dataset into forms applicable to an XAI algorithm.

Subsequently, in 230, the PnP XAI system 1 computes the XAI algorithm of the configured model.

In XAI algorithm computation operation 230, the PnP XAI system 1 may analyze the model to identify its computational structure and may calculate the XAI algorithm using algorithm calculation classes corresponding to the identified computational structure.

Subsequently, in 240, the PnP XAI system 1 visualizes the results including values calculated with the XAI algorithm.

According to the PnP XAI system and a design method thereof, similar to how a computer automatically recognizes and installs a driver when a USB is connected, a machine learning model developed by a user may be recognized and the results of applying and comparing/analyzing an XAI algorithm of the corresponding machine learning model may be promptly provided.

According to the PnP XAI system and a design method thereof, the user's trained machine learning model may be automatically recognized and, upon the user selecting a predetermined XAI algorithm provided in the software, the calculated result of the selected XAI algorithm may be directly provided without the need for a separate function call.

Heretofore, the present invention has been described by focusing on the exemplary embodiments. It can be understood by those skilled in the art to which the present invention pertains that the present invention can be implemented in modified forms without departing from the essential feature of the present invention. Therefore, the disclosed embodiments should be considered as illustrative rather than determinative. The scope of the present invention is defined by the appended claims rather than by the foregoing description, and all differences within the scope of equivalents thereof should be construed as being included in the present invention.

What is claimed is:

1. A plug-and-play explainable artificial intelligence (PnP XAI) system comprising:
a model import module configured to, upon installation of a program in a machine learning model used for training by a user, receive a model configuration file through user input via the installed program, configure a machine learning model using the received model configuration file, and return it to the user;
a dataset import module configured to receive a dataset configuration file through user input via the installed program, configure a dataset using the received dataset configuration file, and return it to the user;
a user manager module configured to receive the returned model and dataset through user input and adjust the received model and dataset into forms applicable to an explainable artificial intelligence (XAI) algorithm;
a kernel manager module configured to receive the model and dataset adjusted into forms applicable to an XAI algorithm; and
an XAI library module configured to receive a model and dataset information from the kernel manager module, calculate an XAI algorithm of a model, and return an XAI algorithm calculation result value to the kernel manager module.

2. The PnP XAI system of claim 1, wherein the model configuration file includes location information of a file, model and dataset call information, XAI algorithm selection information, and parameter information necessary for calling a model.

3. The PnP XAI system of claim 1, wherein the XAI library module comprises an XAI algorithm sub-module and the XAI algorithm sub-module comprises at least one of layer-wise relevance propagation (LRP) sub-module, a gradient-class activation map (GradCAM) sub-module, or an integrated gradient (IG) sub-module.

4. The PnP XAI system of claim 3, further comprising a model tracer module configured to receive a model from the XAI algorithm sub-module, analyze the received model to identify a computational structure of the model, and return algorithm calculation classes corresponding to the identified computational structure to the XAI algorithm sub-module, enabling the XAI algorithm sub-module to calculate the XAI algorithm.

5. The PnP XAI system of claim 1 further comprising a visualization module configured to receive the XAI algorithm calculation result value from the kernel manager module and visualize it.

6. A plug-and-play explainable artificial intelligence (PnP XAI) design method comprising:
installing a program in a machine learning model used for training by a user;
receiving a model configuration file from the user through the installed program;
configuring a machine learning model using the received model configuration file;
calculating an XAI algorithm of the configured machine learning model; and
visualizing a result including a value calculated with the XAI algorithm.

7. The PnP XAI design method of claim 6, further comprising receiving a dataset configuration file from the user and configuring a dataset using the received dataset configuration file.

8. The PnP XAI design method of claim 7, further comprising adjusting the configured model and dataset into forms applicable to an XAI algorithm.

9. The PnP XAI design method of claim 6, wherein in the calculating of the XAI algorithm, the model is analyzed to identify a computational structure of the model and the XAI algorithm is calculated using algorithm calculation classes corresponding to the identified computational structure.
